(19) United States
(12) Patent Application Publication
(10) Pub. No.: US 2020/0088245 A1
(43) Pub. Date: Mar. 19, 2020

(54) CLUTCH COIL THERMAL FUSE HEAT SINK ACTIVATION

(71) Applicant: Hanon Systems, Daejeon (KR)

(72) Inventors: Tim Ewan, Novi, MI (US); Mark Honkala, Howell, MI (US); Steve White, Pinckney, MI (US)

(21) Appl. No.: 16/402,365

(22) Filed: May 3, 2019

Related U.S. Application Data
(60) Provisional application No. 62/731,315, filed on Sep. 14, 2018.

(51) Int. Cl. F16D 27/02; F16D 27/14; F16D 27/112; F16D 48/06; B60H 1/32

(52) U.S. Cl. CPC F16D 27/02; F16D 27/14; F16D 27/112; F16D 2500/5041; B60H 1/3225; F16D 2500/30404; F16D 48/064

(57) ABSTRACT

A thermal fuse activation assembly for a clutch includes a thermal fuse. The thermal fuse has a body containing a temperature sensitive member. The temperature sensitive member is configured to activate upon a predetermined temperature. The thermal fuse activation assembly further includes a heat sink is thermally coupled to the thermal fuse.

### CROSS REFERENCE TO RELATED APPLICATIONS

This patent application claims the benefit of U.S. Provisional Patent Application Ser. No. 62/731,315, filed on Sep. 14, 2018. The entire disclosure of the above patent application is hereby incorporated herein by reference.

### FIELD OF THE INVENTION

The invention relates to an air conditioner clutch assembly, and more particularly to a heat sink and a thermal fuse of an air conditioner clutch assembly.

### BACKGROUND OF THE INVENTION

As commonly known air conditioning systems of vehicles convey a refrigerant there through to transfer heat between an air flowing there through and the refrigerant. The air conditioning system includes a compressor pressurizing and pumping the refrigerant through the air conditioning system. The compressor is driven by an engine, the rotating power of which is transmitted to the compressor via a belt. A clutch is used to control an on and off operation of the compressor when the engine remains on. Due to parameters such as the comfort of passenger of the vehicle or the ambient environment, it may be desired to turn the compressor off during certain operating conditions of the vehicle. Accordingly, an electromagnetic clutch assembly may be used to selectively transmit the torque from the engine to the compressor. The clutch is comprised of three components: a clutch disc, a pulley, and a coil. When a current runs through the coil, the coil is energized and a magnetic force causes the pulley to engage with the clutch disc to mechanically communicate with the compressor, thus causing the compressor to operate. Otherwise, when operation of the compressor is not desired, a gap is formed between the clutch disc and the pulley via a biasing device to mechanically disengage the clutch disc from the compressor.

A properly operating clutch has minimal relative rotational motion or clutch slip between the clutch disc and the pulley despite the engagement therebetween. A problem arises during undesired clutch slip. Undesired clutch slip results in sustained relative rotational motion between the clutch disc and the pulley. The sustained clutch slip action generates heat and can eventually damage the pulley and/or a pulley bearing. Damage to the pulley bearing can result in loss of FEAD (front end accessory drive) drive belt function which can adversely affect the vehicle engine performance.

Frictional forces caused by the relative motion between the clutch disc and the pulley during the clutch slip leads to a generation of heat. Typically, the coil contains a thermal fuse disposed in a face thereof which will “activate” (internal pellets melt) when the thermal fuse internal temperature reaches a predetermined temperature. For example, the thermal fuse will activate when the internal temperature reaches 184 degrees Celsius, for example. The thermal fuse activation creates an open circuit condition. The open circuit condition allows the clutch disc to disengage from the pulley and the relative rotation therebetween stops. As a result, no additional heat is generated.

Currently, customer demands require the thermal fuse to activate as quickly as possible. For example, customer demands may require the thermal fuse to activate within twenty seconds of a given pre-defined operating condition for the clutch disc to disengage from the pulley. Although other demands may require less than one minute or less than two minutes of a given pre-defined operating condition for the thermal fuse to activate. The shorter time requirement applies to all predefined conditions or parameters relating to speed, ambient temperatures, and clutch voltages or any other parameter in which an activation of a thermal fuse is required. Known thermal fuses are known to not activate until a relatively longer time period. For example, a clutch operating under the conditions of 700 rpm, 12 volts and 20 degrees Celsius requires approximately three minutes of clutch slip to activate the thermal fuse. This will not meet the Original Equipment Manufacturer (OEM) requirements for significantly shorter times for thermal fuse activation.

Certain solutions are employed to minimize a time before activation of the thermal fuse. One such solution includes implementing a thermal fuse with lower activation points, wherein the thermal fuse will activate with lower temperatures compared to prior art thermal fuses. This solution is problematic when the compressor is operating under relatively higher ambient temperatures. With the higher ambient temperatures, the thermal fuse is more likely to activate even with no slipping issues, thus resulting in the compressor undesirably turning off.

Another solution utilizes rotational sensors such as shown and described in EP 2372154, the disclosure of which is hereby incorporated herein by reference in its entirety. The rotational sensors detect compressor shaft rotation. Permanent magnets may be attached to the shaft. The rotational sensing is done in a zone of low magnetic field. A temperature sensing device (PTC/NTC) is also used to adjust and adapt the magnetic readings during temperature changes.

Another solution utilizes rotation sensors and/or temperature sensors. An example of a sensor is shown and described in U.S. Pat. Appl. Pub. No. 2007/0017771, the disclosure of which is hereby incorporated herein by reference in its entirety. A Hall-effect sensor is employed to monitor magnetic flux leakage paths and monitor compressor internal part rotation. If the compressor seizes, the Hall-effect sensor will detect the seizure of the compressor.

Another solution, utilizes a temperature switch and/or a thermal fuse that can be used with the air conditioning programming control logic to trigger a warning if a rapid increase in temperature or a high temperature is detected. Upon the trigger of the warning, the clutch can be deactivated. An example of such a solution is shown and described in U.S. Pat. No. 7,040,102, the disclosure of which is hereby incorporated herein by reference in its entirety.

In yet another solution, a thermistor or thermocouple is mounted at any of various positions (a back of the coil, the bearing, the engine) to monitor for a pre-determined maximum temperature. If the temperature is detected, the clutch is disengaged.

However, these solutions still do not result in an activation of the thermal fuse within the desired or required desired shorter time period of a given pre-defined operating parameter resulting from clutch slip.

Therefore, there is a desire for a thermal fuse to activate quickly upon reaching a pre-determined operating parameter to disengage a clutch of a compressor for an air conditioning system.

### SUMMARY OF THE INVENTION

In accordance and attuned with the instant disclosure, a thermal fuse to activate quickly upon reaching a pre-determined operating parameter to disengage a clutch of a compressor for an air conditioning system, has surprisingly been discovered.

According to embodiment of the present disclosure, a thermal fuse activation assembly for a clutch includes a thermal fuse. The thermal fuse has a body containing a temperature sensitive member. The temperature sensitive member is configured to activate upon a predetermined temperature. The thermal fuse activation assembly further includes a heat sink is thermally coupled to the thermal fuse.

According to another disclosure of the present disclosure, a coil assembly of a clutch is disclosed. The coil assembly includes a coil configured to selectively receive electrical current to cause the clutch to operate a compressor. A thermal fuse activation assembly is disposed in an outer facing surface of the coil assembly. The thermal fuse activation assembly includes a thermal fuse in electrical communication with the coil and a heat sink thermally coupled to the thermal fuse.

According to yet another disclosure of the present disclosure, a clutch assembly for a compressor is disclosed. The clutch assembly includes a clutch disc operably coupled to the compressor and a pulley selectively engaging the clutch disc to drive the compressor. A coil assembly includes a coil housing and a potting material. The coil housing receives an electromagnetic coil configured to selectively engage the pulley to the clutch disc. The potting material is formed about the coil and forms a portion of an outer facing surface of the coil assembly. The outer facing surface faces the clutch disc and the pulley. A thermal fuse activation assembly is formed in the outer facing surface of the coil assembly. The thermal fuse activation assembly includes a thermal fuse in electrical communication with the coil and a heat sink thermally coupled to the thermal fuse. A portion of the heat sink is exposed from the coil assembly.

### DRAWINGS

The above, as well as other advantages of the present invention, will become readily apparent to those skilled in the art from the following detailed description of a preferred embodiment when considered in the light of the accompanying drawings in which:

FIG. 1 is a cross-sectional elevational view of an electromagnetic clutch assembly according to the present disclosure;

FIG. 2 is an enlarged fragmentary cross-sectional elevational view of the electromagnetic clutch assembly of FIG. 1, highlighted by circle 2;

FIG. 3 is a top perspective view of a thermal fuse activation assembly of the clutch assembly of FIGS. 1-2;

FIG. 4 is an enlarged fragmentary cross-sectional elevational view of a thermal fuse activation assembly according to another embodiment of the disclosure;

FIG. 5 is an enlarged fragmentary cross-sectional elevational view of a coil assembly according to another embodiment of the disclosure;

FIG. 6 is an enlarged fragmentary cross-sectional elevational view of a coil assembly according to another embodiment of the disclosure;

FIG. 7 is an enlarged fragmentary cross-sectional elevational view of a coil assembly according to another embodiment of the disclosure; and

FIGS. 8A-8C are enlarged fragmentary cross-sectional elevational views of a coil assembly according to another embodiment of the disclosure, wherein various examples of weld joints are illustrated.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the order of the steps presented is exemplary in nature, and thus, is not necessary or critical.

A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. Where any conflict or ambiguity may exist between a document incorporated by reference and this detailed description, the present detailed description controls.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “bottom,” “top,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

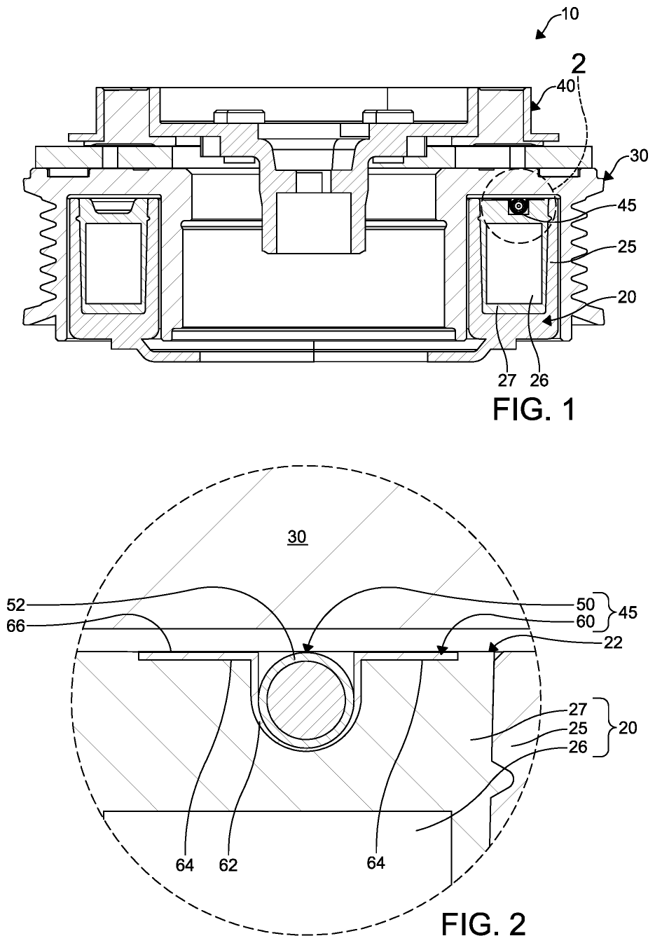

FIG. 1 illustrates a cross-sectional view of an electromagnetic clutch assembly 10 according to an embodiment of the present disclosure is illustrated. The clutch assembly 10 is configured for use with a compressor, wherein the clutch assembly 10 is configured as a portion of an automobile heating, ventilating, and air conditioning (HVAC) system. The clutch assembly 10 includes a coil assembly 20, a pulley 30, and a clutch disc 40. The coil assembly 20 includes a coil housing 25, an electromagnetic coil 26, and a potting material 27 electrically insulating the coil 26 from the housing 25. The potting material 27 is formed from a synthetic polymer such as nylon or polymide resin. In a non-limiting example, the potting material 27 is nylon 66. Although, other potting materials now known or later developed can be employed as desired such as epoxies or unsaturated polyester.

A shaft (not shown) of the compressor engages a hub of the clutch disc 40. The pulley 30 may normally rotate about a central axis thereof by means of a drive belt (not shown) mechanically coupled to the output shaft of the engine, including when the compressor is not in operation. When the compressor is not in use, a gap is formed between the pulley 30 and the clutch disc 40, wherein the gap may be maintained via use of a biasing device (not shown) that normally biases the clutch disc 40 in a direction away from the pulley 30.

When it is desirable for the compressor to operate, such as when cool air is desired within a passenger compartment of the automobile, the coil 20 is energized in a manner wherein an electromagnetic force attracts the clutch disc 40 towards the pulley 30 to eliminate the gap. The clutch disc 40 then engages the pulley 30 to transfer power from the drive belt to the shaft, thereby driving the internal component of the compressor. The engagement between the clutch disc 40 and the pulley 30 preferably occurs without any relative motion therebetween in order to efficiently transfer the power of the engine to the internal components of the compressor.

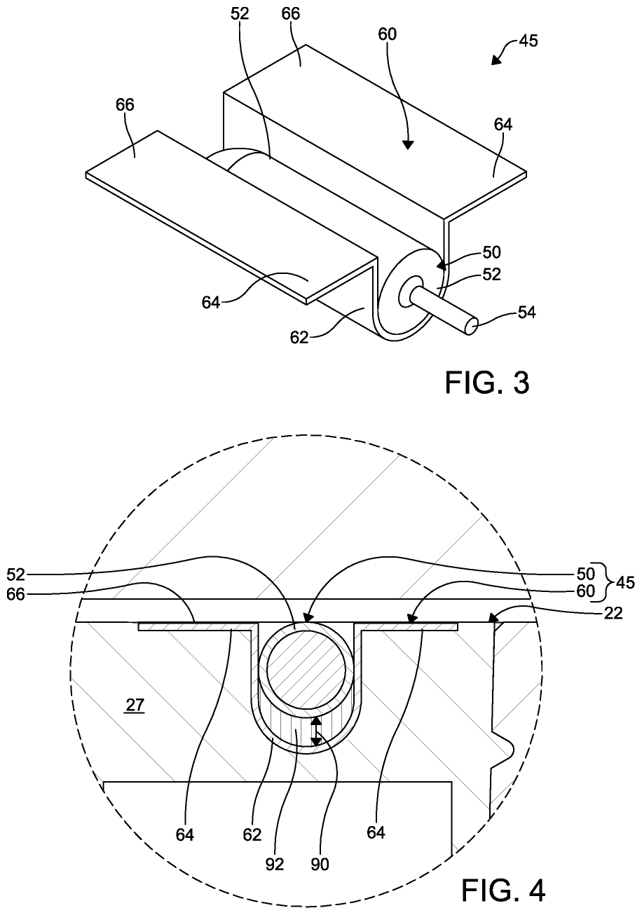

As shown in FIGS. 1-3, the coil assembly 20 further includes a thermal fuse activation assembly 45 having a thermal fuse 50 and a heat sink 60. The thermal fuse activation assembly 45 is disposed in an outer facing surface 22 of the coil assembly 20, wherein the outer facing surface 22 faces towards the engaging surfaces of the pulley 30 and the clutch disc 40. The thermal fuse activation assembly 45 can be formed in a substantially central portion of the outer facing surface 22 with respect to a width of the outer facing surface 22. Although, in other embodiments the thermal fuse activation assembly 45 can be formed in a substantially non-central portion of the outer facing surface 22 with respect to a width of the outer facing surface 22, if desired. The potting material 27 is formed about portions of the thermal fuse activation assembly 45 to embed and maintain the thermal fuse activation assembly 45 in the coil assembly 20. The potting material 27 is over molded to cover the coil 26 and portions of the thermal activation assembly 45 by an injection molding process for example as a final step of the assembling of the coil assembly 20. However, other methods and processes of forming the coil assembly 20 can be contemplated. When embedded into the coil assembly 20, a portion of the thermal fuse activation assembly 45 is exposed outwardly from the coil assembly 20.

The thermal fuse 50 is in electrical communication with the coil 26. The thermal fuse 50 includes a body 52 containing a temperature sensitive member which is melted or fused (activated) at a predetermined temperature, a pair of contacts, and a spring (not shown). A pair of leads 54 extends outwardly in a lengthwise direction from body 52 to engage the coil 26. The thermal fuse 50 is spliced in-series with the coil 26. Prior to the activation of the temperature sensitive member of the thermal fuse 50, a closed electrical circuit between the contacts is created. Upon activation of the thermal fuse 50, the temperature sensitive member is melted or fused which activates a force of the spring to cause the contacts to be separated from each other. As a result, an open circuit condition is communicated to the clutch disc 40 in order to disengage the clutch disc 40 and the pulley 30. The thermal fuse 50 is configured to activate upon undesired relative motion between the clutch disc 40 and the pulley 30, also known as “clutch slip”. For example, the undesired relative motion between the clutch disc 40 and the pulley 30 results in heat being transferred from between the clutch disc 40 and the pulley 30 to an area adjacent the thermal fuse 50. The heat causes a rise in temperature. Upon achieving the predetermined temperature, the thermal fuse 50 activates to prevent the undesired relative motion between the clutch disc 40 and the pulley 30.

The heat sink 60 is disposed intermediate the thermal fuse 50 and the outer facing surface 22 of the coil assembly 20 and directly engages the thermal fuse 50. The heat sink 60 extends along as entire length of the body 52 of the thermal fuse 50. The heat sink 60 is formed from a material with a high thermal conductivity such as aluminum, copper, brass, or composite thereof Although, it should be understood, the heat sink 60 can be formed from other metals or non-metallic materials now known or later developed with a high thermal conductivity.

The heat sink 60 includes a first portion 62 directly engaging the thermal fuse 50 and a second portion 64 having a surface 66 exposed from the coil assembly 20. The surface 66 faces the engagement surfaces between the pulley 30 and the clutch plate 40. The first portion 62 has a substantially arcuate cross-sectional shape to correspond to the cross-sectional shape of the thermal fuse 50. However, it is understood, other cross-sectional shapes of the first portion 62 can be contemplated to correspond to the shape of the thermal fuse 50, if desired, such as a polygonal cross-sectional shape. The second portion 64 is configured as a pair of planar flanges each extending laterally outwardly from the first portion 62. The second portion 64 engages the outer facing surface 22 of the coil assembly 20. In the embodiment illustrated, the surface 66 is aligned with or continuous with the outer facing surface 22. However, it is understood, the surface 66 can be slightly raised from or slightly recessed into the outer facing surface 22.

During the over molding process of the potting material 27, the potting material 27 flows about the heat sink 60 and to engage portions of the heat sink 60. As a result, the heat sink 60 is embedded and maintained in the coil assembly 20 by the potting material 27. An epoxy (not shown) or thermal adhesive may also be employed to maintain the heat sink 60 to the coil assembly 20 before and/or after the potting material 27 is injected into the coil assembly 20. For example, epoxy may be applied to the heat sink 60 and filled into spots adjacent to the heat sink 60. The thermal fuse 50 is maintained within the first portion 62 of the heat sink 60 by a friction fit, weld, solder, adhesive, or other coupling means, as desired. For example, a solid state ultrasonic weld can be formed between the first portion 62 of the heat sink 60 and the thermal fuse 50. For advantageous activation time of the thermal fuse 50, it has been found that a thickness of the heat sink 60 is optimal in a range of about 0.1 millimeters to 0.2 millimeters. However, depending on the predetermined temperature, a desired activation time, configurations of the clutch assembly 10, and other application parameters of the clutch assembly 10 the thickness of the heat sink 60 can be less than 0.1 millimeters or greater than 0.2 millimeters, as desired. Advantageously, to achieve faster activation times, the surface 66 exposed from the coil assembly 20 has a surface area greater than or equal to 50 millimeters squared. Although, the surface area of the surface 66 can be less than 50 millimeters squared, if desired.

In application, in order to achieve the predetermined temperature to activate the thermal fuse 50 more rapidly, heat is more rapidly transferred to the thermal fuse 50 via the heat sink 60. Specifically, during an undesired condition such as clutch slip, heat is generated between the pulley 30 and the clutch disc 40. The heat is transferred to the heat sink 60 via radiation and convection from the atmosphere surrounding the heat sink 60 and via conduction from the potting material 27. The heat transferred to the heat sink 60 is then transferred to the thermal fuse 50 via conduction. As a result, the heat sink 60 transfers the heat generated by the clutch slip to the thermal fuse 50 more rapidly than prior art configurations.

According to another embodiment, as illustrated in FIG. 4, a gap 90 is formed intermediate the thermal fuse 50 and the heat sink 60 such as between the first portion 62 of the heat sink 60 and the thermal fuse 50. A thermal paste 92 is disposed in the gap 90 to facilitate coupling the thermal fuse 50 to the heat sink 60 and/or to facilitate a faster transfer of heat from the heat sink 60 to the thermal fuse 50 for faster activation of the thermal fuse 50. In the embodiment illustrated, the thermal paste 92 is disposed between the first portion 62 of the heat sink 60 and the thermal fuse 50. However, the thermal paste 92 can also be disposed intermediate the second portion 64 of the heat sink 60 and the potting material 27, if desired. The thermal paste 92 is a thermally conductive paste, adhesive, tape, or compound that may or may not also form a bond between the heat sink 60 and the thermal fuse 50. For example, the thermal paste 92 is formed from a polymerizable liquid matrix such as epoxy, silicone, and urethane and thermally conductive filler such as a metal, a metal oxide, or silica, for example. However, it is understood other materials can be used as desired to form the thermal paste 92.

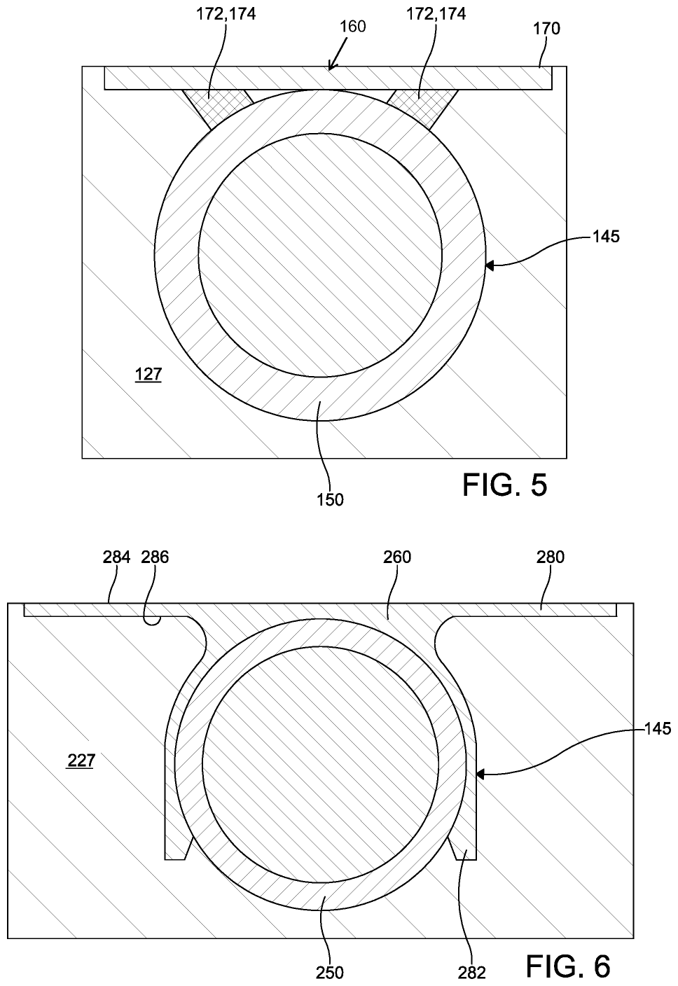

FIG. 5 illustrates a coil assembly 120 according to another embodiment of the instant disclosure. The coil assembly 120 is substantially similar to the coil assembly 20 of FIGS. 1-3, except the coil assembly 120 of FIG. 5 includes a configuration of the thermal fuse activation assembly 145 different from the configuration of the thermal fuse activation assembly 45 of FIGS. 1-3. Features of the coil assembly 120 of FIG. 5 similar to features of the coil assembly 20 of FIGS. 1-3 are represented by the same reference numeral except with a leading one “1” for convenience.

The heat sink 160 is entirely disposed above the thermal fuse 150 rather than a portion thereof in between the thermal fuse 150 and the outer facing surface 122 of the coil assembly 120. In the embodiment illustrated, the heat sink 160 is a continuous plate with a continuous planar surface 170 exposed from the coil assembly 120 extending over the thermal fuse 150. In the embodiment illustrated, the surface 170 is aligned with or continuous with the outer facing surface 122. However, it is understood, the surface 170 can be slightly raised from or slightly recessed into the outer facing surface 122. The heat sink 160 is centered on the outer facing surface 122 of the coil assembly 120 with respect to a width of the coil assembly.

The thermal fuse 150 is embedded in the potting material 127 at a distance from the outer facing surface 122 of the coil assembly 120. The thermal fuse 150 is thermally coupled to the heat sink 160 by a link 172 formed from a conductive material. As shown in FIG. 5, the link 172 is a pair of solder connections 174, formed by a solder with a soldering process, thermally and structurally connecting the heat sink 160 to the thermal fuse 150. However, it is understood, the link 172 can be more than or fewer than two of the solder connections 174. Additionally, according to other alternate embodiments, the link 172 can be one or more weld connections or other bonding connections, if desired.

The heat sink 160 is formed from a metal with a high thermal conductivity such as aluminum, copper, brass, or composite thereof Although, it should be understood, the heat sink 160 can be formed from other materials now known or later developed with a high thermal conductivity. Advantageously, to achieve faster activation times, the exposed surface 170 has a surface area greater than or equal to 50 millimeters squared. Although, it is understood, the exposed surface 170 can be less than 50 millimeters squared, if desired.

In application, in order to achieve the predetermined temperature to activate the thermal fuse 150 more rapidly, heat is more rapidly transferred to the thermal fuse 150 via the heat sink 160. Specifically, during an undesired condition such as clutch slip, heat is generated between the pulley 30 and the clutch disc 40. The heat is transferred to the heat sink 160 via radiation and convection from the atmosphere surrounding the heat sink 160 and via conduction from the potting material 127. The heat transferred to the heat sink 160 is then transferred to the thermal fuse 150 via conduction through the link 172. As a result, the heat sink 160 transfers the heat generated by the clutch slip to the thermal fuse 150 more rapidly than prior art configurations.

FIG. 6 illustrates a coil assembly 220 according to another embodiment of the instant disclosure. The coil assembly 220 is substantially similar to the coil assemblies 20, 120 of FIGS. 1-3 and 5, except the coil assembly 220 of FIG. 5 includes a configuration of the thermal fuse activation assembly 245 different from the configuration of the thermal fuse activation assembly 45, 145 of FIGS. 1-3 and 5. Features of the coil assembly 220 of FIG. 6 similar to features of the coil assemblies 20, 120 of FIGS. 1-3 and 5 are represented by the same reference numeral except with a leading two “2” for convenience.

Similar to the coil assembly 120 of FIG. 5, the heat sink 260 is entirely disposed above the thermal fuse 250 rather than a portion thereof in between the thermal fuse 250 and the outer facing surface 222 of the coil assembly 220. However, the heat sink 260 is divided into a planar first portion 280 with a planar exposed surface 284 and an arcuate second portion 282 with an arcuate cross-sectional shape disposed intermediate the first portion 280 and the thermal fuse 250. The second portion 282 has a substantially C-shaped cross-section to correspond in shape with the thermal fuse 250. The second portion 282 is integrally formed with the first portion 280 and extends outwardly from an inner surface 286 of the first portion 280. In the embodiment illustrated, a substantially central apex portion of the second portion 282 is connected to a substantially central widthwise portion of the first portion 280. As a result, a pair of substantially equal parts of the first portion 280 extends laterally from the central portion of the second portion 282. The second portion 282 curves concave with respect to the first portion 280 to curve about and directly engage a portion of the thermal fuse 250. Although, it is understood a gap can be formed between the second portion 282 and the thermal fuse 250 with a thermal paste formed therein.

In the embodiment illustrated, the surface 284 is aligned with or continuous with the outer facing surface 222. However, it is understood, the surface 284 can be slightly raised from or slightly recessed into the outer facing surface 222. The thermal fuse 250 and the second portion 282 of the heat sink 260 are embedded in the potting material 227 at a distance from the outer facing surface 222 of the coil assembly 220.

The heat sink 260 is formed from a metal with a high thermal conductivity such as aluminum, copper, brass, or composite thereof Although, it should be understood, the heat sink 260 can be formed from other materials now known or later developed with a high thermal conductivity. Advantageously, to achieve faster activation times, the surface 284 has a surface area greater than or equal to 50 millimeters squared. Although, it is understood, the surface area of the surface 284 can be less than 50 millimeters squared, if desired.

In application, in order to achieve the predetermined temperature to activate the thermal fuse 250 more rapidly, heat is more rapidly transferred to the thermal fuse 250 via the heat sink 260. Specifically, during an undesired condition such as clutch slip, heat is generated between the pulley 30 and the clutch disc 40. The heat is transferred to the heat sink 260 via radiation and convection from the atmosphere surrounding the heat sink 260 and via conduction from the potting material 227. The heat transferred to the heat sink 260 is then directly transferred to the thermal fuse 250. The second portion 282 provides a greater surface area engagement between the thermal fuse 250 and the heat sink 260. As a result, the heat sink 260 transfers the heat generated by the clutch slip to the thermal fuse 250 more rapidly than prior art configurations.

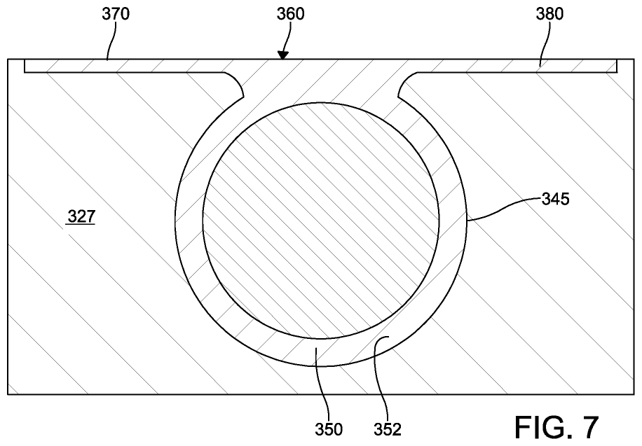

FIG. 7 illustrates a coil assembly 320 according to another embodiment of the instant disclosure. The coil assembly 320 is substantially similar to the coil assemblies 20, 120, 220 of FIGS. 1-3 and 5-6, except the coil assembly 320 of FIG. 7 includes a configuration of the thermal fuse activation assembly 345 different from the configuration of the thermal fuse activation assembly 45, 145, 245 of FIGS. 1-3 and 5-6. Features of the coil assembly 320 of FIG. 7 similar to features of the coil assemblies 20, 120, 220 of FIGS. 1-3 and 5-6 are represented by the same reference numeral except with a leading three “3” for convenience.

In FIG. 7, the heat sink 360 and the thermal fuse 350 are integrally formed with each other to form a monolithically formed thermal fuse activation assembly 345. For example, the heat sink 360 and the body 352 of the thermal fuse 350 are formed together from a single extruded piece of material. However, it is understood, the heat sink 360 and the thermal fuse 360 can be integrally formed from other processes as desired such as a molding process, for example. In the embodiment illustrated, the heat sink 360 is substantially planar and is disposed above the thermal fuse 350 with the surface 370 exposed from the coil assembly 320. The body 352 of the thermal fuse 350 is annular. An outer circumferential portion of the thermal fuse 350 interfaces with the heat sink 360 at a substantially central portion of the heat sink 360.

The heat sink 360 and thermal fuse 350 are integrally formed from a metal with a high thermal conductivity such as aluminum, copper, brass, or composite thereof Although, it is understood, the heat sink 360 and the thermal fuse 350 can be formed from other materials now known or later developed with a high thermal conductivity. Advantageously, to achieve faster activation times, the surface 370 has a surface area greater than or equal to 50 millimeters squared. Although, it is understood, the surface area of the surface 370 can be less than 50 millimeters squared, if desired.

In application, in order to achieve the predetermined temperature to activate the thermal fuse 350 more rapidly, heat is more rapidly transferred to the thermal fuse 350 via the heat sink 360 which is integrally formed therewith. Specifically, during an undesired condition such as clutch slip, heat is generated between the pulley 30 and the clutch disc 40. The heat is transferred to the heat sink 360 via radiation and convection from the atmosphere surrounding the heat sink 360 and via conduction from the potting material 327. The heat transferred to the heat sink 360 is then directly and integrally transferred to the thermal fuse 350. As a result, the heat sink 360 transfers the heat generated by the clutch slip to the thermal fuse 350 more rapidly than prior art configurations.

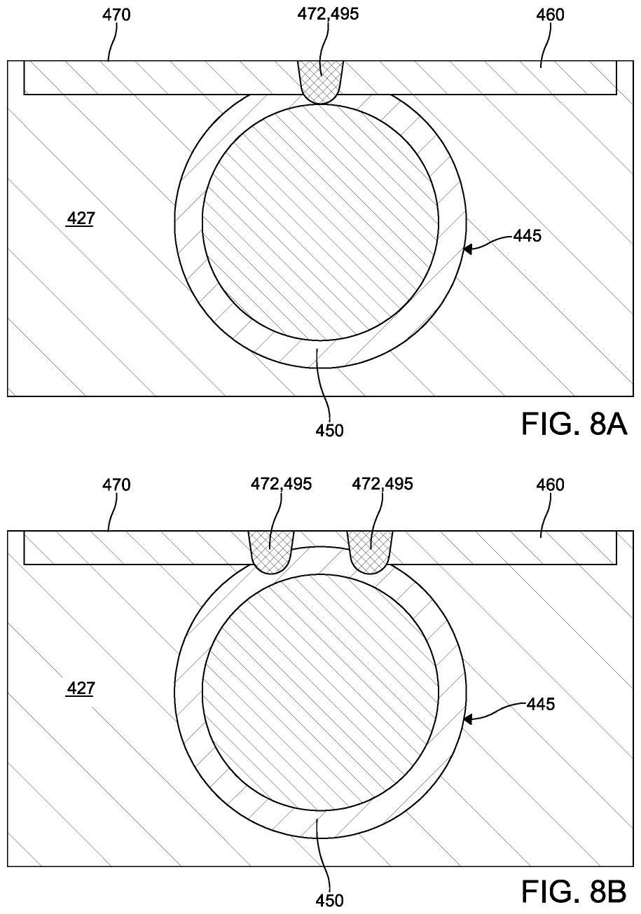

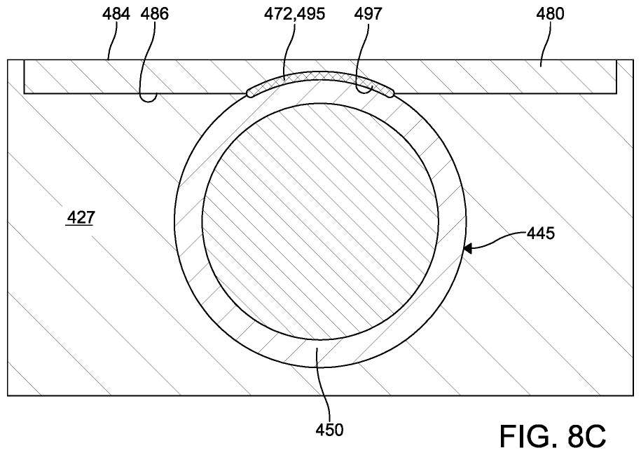

FIGS. 8A-8C illustrate coil assemblies 420 according to another embodiment of the instant disclosure. The coil assemblies 420 are substantially similar to the coil assembly 120 of FIG. 5, except the coil assemblies 420 of FIGS. 8A-8C illustrate various types of the links 172 configured as welds coupling the heat sink 460 to the thermal fuse 450. Features of the coil assembly 120 of FIGS. 8A-8C similar to features of the coil assembly 120 of FIG. 5 are represented by the same reference numeral except with a leading four “4” for convenience.

In FIG. 8A, the heat sink 460 is coupled to the thermal fuse 450 by a single weld joint 495 such as a single fusion weld, for example. FIG. 8B illustrates the heat sink 460 is coupled to the thermal fuse 450 by a pair of the weld joints 495. In the embodiment illustrated in FIG. 8B, the heat sink 460 includes an arcuate recessed surface 497 formed therein for engaging the thermal fuse 450. As a result, a greater surface area between the heat sink 460 and the thermal fuse 450 is in contact to increase thermal transfer there between. In FIG. 8C, the weld joint 495 is disposed along a length of the arcuate recessed surface 497 between the heat sink 460 and the thermal fuse 450. The weld joint 495 is formed from a solid state weld such as an ultrasonic weld, for example. It is understood, the heat sink 460 and the thermal fuse 450 can have any configuration as desired, such as any of the configurations shown in FIGS. 1-7 with a weld joint or joint formed from any welding process. Additionally, the weld joint 495 can be formed at any portion between the heat sink 460 and the thermal fuse 450.

It is also understood, other configurations of the thermal fuse activation assembly 45, 145, 245, 345, 445 can be contemplated without departing from the scope of the disclosure. The thermal fuse activation assembly 45, 145, 245, 345, 445 can be a combination of the embodiments illustrated herein.

Advantageously, the thermal fuse activation assembly 45, 145, 245, 345, 445 of the present disclosure causes the thermal fuse 50, 150, 250, 350, 450 to activate more quickly than prior art thermal fuses upon a clutch slip condition of the clutch assembly 10.

While certain representative embodiments and details have been shown for purposes of illustrating the invention, it will be apparent to those skilled in the art that various changes may be made without departing from the scope of the disclosure, which is further described in the following appended claims.

What is claimed is:

1. A thermal fuse activation assembly for a clutch comprising:
a thermal fuse including a body containing a temperature sensitive member configured to activate upon a predetermined temperature; and
a heat sink thermally coupled to the thermal fuse.

2. The thermal fuse activation assembly of claim 1, wherein the heat sink is formed from a material with a high thermal conductivity.

3. The thermal fuse activation assembly of claim 1, wherein the heat sink directly engages the thermal fuse.

4. The thermal fuse activation assembly of claim 1, wherein the heat sink is coupled to the thermal fuse by one of a solder connection and a weld joint.

5. The thermal fuse activation assembly of claim 1, wherein the heat sink includes a substantially arcuate portion and a substantially planar portion.

6. The thermal fuse activation assembly of claim 5, wherein the arcuate portion directly engages the thermal fuse.

7. The thermal fuse activation assembly of claim 5, wherein the planar portion is one of a continuous plate or a pair of flanges extending laterally outwardly from the arcuate portion.

8. The thermal fuse activation assembly of claim 7, wherein the planar portion is the continuous plate and the arcuate portion extends from a center of the planar portion.

9. The thermal fuse activation assembly of claim 1, wherein the thermal fuse and the heat sink are integrally formed with each other.

10. The thermal fuse activation assembly of claim 1, wherein the heat sink extends along an entire length of the thermal fuse.

11. The thermal fuse activation assembly of claim 1, further comprising a thermal paste disposed intermediate the heat sink and the thermal fuse.

12. A coil assembly of a clutch comprising:
a coil configured to selectively receive electrical current to cause the clutch to operate a compressor; and
a thermal fuse activation assembly disposed in an outer facing surface of the coil assembly, the thermal fuse activation assembly including a thermal fuse in electrical communication with the coil and a heat sink thermally coupled to the thermal fuse.

13. The coil assembly of claim 12, further comprising a potting material formed about the coil and a portion of the thermal fuse activation assembly, wherein the potting material forms a portion of the outer facing surface of the coil assembly.

14. The coil assembly of claim 12, wherein the heat sink includes a surface exposed from the outer facing surface of the coil assembly, wherein the surface exposed from the outer facing surface of the coil assembly has a surface area greater than fifty square millimeters.

15. The coil assembly of claim 12, wherein the thermal fuse activation assembly includes a thermal paste disposed intermediate the thermal fuse and the heat sink.

16. The coil assembly of claim 12, wherein the heat sink is integrally formed with the thermal fuse or coupled to the thermal fuse by one of a solder connection and a weld joint.

17. The coil assembly of claim 12, wherein a first portion of the heat sink is substantially planar.

18. The coil assembly of claim 17, wherein a second portion of the heat sink has an arcuate cross-sectional shape, and wherein the second portion is disposed intermediate the thermal fuse and the first portion of the heat sink or intermediate the thermal fuse and a potting material formed about a portion of the thermal fuse activation assembly.

19. A clutch assembly for a compressor comprising:
a clutch disc operably coupled to the compressor;
a pulley selectively engaging the clutch disc to drive the compressor;
a coil assembly including a coil housing and a potting material, the coil housing receiving an electromagnetic coil configured to selectively engage the pulley to the clutch disc, the potting material formed about the coil and forming a portion of an outer facing surface of the coil assembly, the outer facing surface facing the clutch disc and the pulley; and
a thermal fuse activation assembly formed in the outer facing surface of the coil assembly, the thermal fuse activation assembly including a thermal fuse in electrical communication with the coil and a heat sink thermally coupled to the thermal fuse, a portion of the heat sink exposed from the coil assembly.

20. The clutch assembly of claim 19, wherein the heat sink is integrally formed with the thermal fuse, separately formed from the thermal fuse and coupled to the thermal fuse by one of a weld joint and a solder connection, or separately formed from the thermal fuse and directly engaging one of the thermal fuse and a thermal paste disposed intermediate the thermal fuse and the heat sink.
